(19) United States
(12) Patent Application Publication
(10) Pub. No.: US 2025/0207438 A1
(43) Pub. Date: Jun. 26, 2025

(54) DOOR HANDLE AND ASSEMBLY METHOD TO MITIGATE COMPONENT TOLERANCES

(71) Applicant: MINEBEA ACCESSSOLUTIONS ITALIA S.P.A., Pianezza (IT)

(72) Inventors: Marco SAVANT, PIANEZZA (IT); Antonio ROCCI, PIANEZZA (IT)

(73) Assignee: MINEBEA ACCESSSOLUTIONS ITALIA S.P.A., Pianezza (IT)

(21) Appl. No.: 18/983,828

(22) Filed: Dec. 17, 2024

(30) Foreign Application Priority Data
Dec. 22, 2023 (EP) 23220114.5

(51) Int. Cl. E05B 79/06; E05B 85/10

(52) U.S. Cl. CPC E05B 79/06; E05B 85/10

(57) ABSTRACT

The invention relates to a door handle configured to be mounted on a door of a motor vehicle, including a handle part, a compressible part adapted to receive at least part of a screwing assembly, and a metal part. The invention also relates to a subassembly of the door handle and the screwing assembly and to an assembly of a door panel and the subassembly. The invention also relates to a method for assembling the door panel and the subassembly or the assembly.

### CROSS-REFERENCE TO RELATED APPLICATIONS

This application claims priority to and the benefit of EP 23220114.5 filed on Dec. 22, 2023, the disclosure of which is incorporated herein by reference.

### FIELD

The present disclosure relates to a door handle configured to be mounted on a door of a motor vehicle, to an assembly of the door handle with a door panel and to a method for assembling the door panel and the door handle.

### BACKGROUND

The statements in this section merely provide background information related to the present disclosure and may not constitute prior art.

Due to the manufacturing tolerances of components typically used in automotive applications, and the fact that some parts can expand and change volume when subjected to thermal stress, misalignments can occur between different components when they are assembled during vehicle manufacturing. For example, when assembling a door handle with a corresponding door panel, misalignment can occur between the handle and the door panel.

Misalignments between components can lead to a number of problems including reduced performance. For example, misalignment between a door handle and a door panel can make the handle difficult to operate or create some aesthetical issues.

In order to prevent misalignments, it is known in the state of the art to use precision manufacturing, i.e. to manufacture components with very tight tolerances to minimize the amount of variation in their dimensions. However, this technique has proven to be expensive and to require significant manufacturing efforts.

Furthermore, it is known in the state of the art to use an electro-corrosion-free connection such that the one disclosed in EP1929161 in order to compensate for these misalignments. However, these connections can be complex and expensive to manufacture. This is because electro-corrosion-free connections often require specialized materials and manufacturing processes. Another downside of electro-corrosion-free connections is that they can be difficult to inspect and maintain.

### SUMMARY

This section provides a general summary of the disclosure and is not a comprehensive disclosure of its full scope or all of its features.

The aim of the present invention is to solve at least part of the above-mentioned drawbacks.

In particular, the invention is intended to provide a vehicle door handle, an assembly of this handle with a vehicle door panel and an assembly method, which are economical and simple to implement during automobile manufacturing.

The invention relates to a door handle configured to be mounted on a door of a motor vehicle. The door handle includes: a handle part; a compressible part adapted to receive at least part of a screwing assembly so as to allow to assemble together the handle part and a door panel; and a metal part extending at least partially around the compressible part and at least partially between the handle part and the compressible part.

Advantageously, the structure of the described door handle is adapted to receive at least part of the screwing assembly in order to be easily and conveniently assembled with a door panel during the manufacturing process.

The door handle can also have one or more of the following features, taken alone or in combination.

The compressible part has a hole adapted to receive at least part of the screwing assembly so as to allow to assemble together the handle part and a door panel.

Advantageously, the hole facilitates the insertion of the screwing assembly into the compressible part.

The handle part has a through-hole, and the compressible part extends along an axis of the through-hole, at least partially in the through-hole, and the compressible part extends, for example radially, from said axis towards the handle part.

The compressible part is configured to deform when in contact with the screwing assembly.

The compressible part may advantageously deform and exert an elastic force on the part of the screwing assembly that is inserted in the compressible part so as to adjust the insertion path of the screwing assembly into the compressible part and therefore mitigate any misalignment between the handle and the door panel.

The compressible part is configured to deform in at least one of the following directions, for example in any of the following direction: a direction orthogonal to an axis of the through-hole and a direction along an axis of the through-hole.

For example, while the compressible part compresses in the direction along an axis of the through-hole, compression of the compressible part in the direction orthogonal to an axis of the through-hole may be restricted or prevented by the screwing assembly, and hence the screwing assembly may exert a force on the compressible part in the direction orthogonal to the axis of the through-hole.

The metal part and the compressible part are arranged such that the metal part extends further than the compressible part along an axis of the through-hole, for example so as to allow the compressible part to deform along the same axis upon reception of the screwing assembly.

The compressible part and the metal part are ring-shaped.

A ring-shaped part has a good weight distribution, which means that it is less likely to cause vibration or noise. It is also easy to manufacture.

The handle part comprises a first portion configured to rest on a door panel, for example on an outer side of a door panel, and a second portion having the through-hole and extending from the first portion, for example in a direction orthogonal to an axis of the through-hole.

The described shape of the door handle allows it to be easily assembled with a door panel.

The compressible part comprises an elastomer, in particular foam or rubber.

Elastomeric materials are generally very durable and resistant to wear and tear.

The metal part comprises a metal chosen from the list comprising the following metals: steel, aluminum, brass.

Advantageously, the metal part can withstand high loads and forces without failing and does not deform easily under load.

The invention also relates to a subassembly of a door handle and a screwing assembly, comprising: the door handle according to what has been previously described; a screwing assembly comprising a screw configured to be inserted at least partially in the compressible part.

The subassembly can also have one or more of the following features, taken alone or in combination.

The screwing assembly is inserted at least partially in the compressible part. For example, the screwing assembly is screwed at least partially in the compressible part.

The screw has a sharp tip.

The tip may be a conical shaped tip.

The screwing assembly comprises a washer configured to be positioned on the screw between a head of the screw and around a shaft of the screw.

The washer helps in distributing the load or force applied by the screw on the section so as to prevent the screw from damaging the handle part.

The invention also relates to an assembly of a door panel and a subassembly according to what has been previously described. The assembly includes: the subassembly according to what has been previously described; a door panel having an aperture adapted to receive at least part of the screwing assembly, so as to assemble together the subassembly and the door panel.

The assembly allows mitigating any misalignment due to manufacturing component tolerances.

The invention also relates to a method for assembling a door panel and the subassembly according to what has been previously described, or the assembly previously described. The method includes the following steps: providing the subassembly; positioning the subassembly so as to have the compressible part facing the aperture of the door panel; tightening the screwing assembly until at least part of the screwing assembly is in contact with the metal part, and until at least part of the screwing assembly passes through both the compressible part and the aperture, and when the screwing assembly is in contact with the compressible part, the compressible part deforms and exerts an elastic force on the screwing assembly so as to secure the subassembly and the door panel together.

Advantageously, the method uses a single screwing operation so it is simple and convenient to implement during a vehicle manufacturing.

Advantageously, the method helps mitigating any misalignment due to manufacturing component tolerances.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 shows a cross-sectional view of a door handle according to the invention.

FIG. 2 shows a cross-sectional view of a subassembly of the door handle from FIG. 1 and a screwing assembly.

FIG. 3 shows a cross-sectional view of an assembly of the subassembly of FIG. 2 and a door panel.

FIG. 4a shows a detailed view of the assembly area of FIG. 2.

FIG. 4b shows a sectional view of the assembly area according to section AA from FIG. 4a.

FIG. 5a shows a cross-sectional view of the same assembly of FIG. 3 when a misalignment between the assembly and the door panel occurs.

FIG. 5b shows a sectional view of the assembly area from FIG. 5a when a misalignment between the assembly and the door panel occurs.

FIG. 6a shows a first step of providing the subassembly of a method for assembling together the subassembly and the door panel.

FIG. 6b shows a second step of positioning the subassembly so as to have the compressible part facing the aperture of the door panel.

FIG. 6c shows a third step of tightening the screwing assembly.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

The invention relates to a door handle 10 intended to be mounted on a door of a motor vehicle, the motor vehicle being for example a car. The door is for example a car door.

The door handle may be located nearby or on the B-pillar area or C-pillar area and/or in continuity of the window sealing. The door handle may be located near or on the B-pillar or C-pillar area and/or for example in continuity of the window sealing. Such positioning may facilitate easy and ergonomic access for the vehicle occupants. By near a certain pillar, it is for example intended that the door handle is located closer to the certain pillar than to another, for example closer to the B-pillar than to the C-pillar or the opposite, for example closer to the certain pillar than to any of the remaining pillars, for example among the remaining pillars among the A-pillar, the B-pillar, the C-pillar or the D-pillar, for example on one side of the car, or that the door handle is located closer the certain pillar than to any other equivalent structural element of the car.

For example, the door handle is located between the B-pillar and the C-pillar, or the B-pillar is located between the door handle and the C-pillar, for example in continuity of the window sealing.

The window sealing is for example the window sealing of the door, or a window sealing common to the door and to another door of the motor vehicle.

The door handle 10 may be positioned on the same side as the B-pillar or C-pillar C of the car.

More specifically, the handle may be located in close proximity to either B-pillar or C-pillar and/or in continuity of the window sealing, thereby facilitating easy and ergonomic access for the vehicle occupants.

The door handle 10 is presented in FIG. 1.

The door handle 10 comprises: a handle part 1; a compressible part 2 adapted to receive at least part of a screwing assembly 3 so as to allow to assemble together the handle part 1 and a door panel 4; and a metal part 5 extending at least partially around the compressible part 2 and at least partially between the handle part 1 and the compressible part 2.

Advantageously, the structure of the described door handle is adapted to receive at least part of the screwing assembly in order to be easily and conveniently assembled with a door panel during the manufacturing process.

The handle part 1 may have a through-hole 7 that allows the handle part 1 to be easily assembled with the door panel 4.

The handle part 1 may comprise one or more organic polymers, for example polycarbonate, ABS, polypropylene, polyamide glass fiber charged or other thermoplastics. This allows the handle part 1 to be lightweight, durable, and resistant to water and chemicals. For example, the handle part may be made of one or more organic polymers.

The handle part 1 may comprise a first portion 1a configured to rest on the door panel 4, for example on an outer side of a door panel 4.

By outer side of a door panel, it is meant the exterior surface of a car door panel, the part of the door that is visible from the outside of the car.

As can be seen from FIG. 1, the first portion 1a may have a T-shape. The T-shape allows the first portion 1a to slide inside a space of the car all while resting on a door panel 4. The first portion 1a may comprise a first part 1a1 and a second part 1a2 which extends from the first part 1a1 towards the second portion 1b. The first part 1a1 may be a cross arm of the first portion 1a and the second part 1a2 may be the shaft that extends from the cross arm. This shape for the first portion 1a allows the first portion 1a to be easily assembled with a door panel.

The first portion 1a may have a chamfer on at least one edge. The radius of curvature of the chamfer may be greater than or equal to 2.5 mm. This reduces the risk of injury for a user that may touch the handle part 1.

The handle part 1 may also comprise a second portion 1b that extends from the first portion 1a, for example in a direction orthogonal to an axis X of the through-hole 7.

The second portion 1b may have a rectangular shape.

The first portion 1a may be made in one piece with the second portion 1b. The first portion 1a and the second portion 1b may be a single part molded in one piece. Alternatively, the second portion 1b may be overmolded onto the first portion 1a, for example according to a two-step process, for example after the molding of the first portion 1a. Alternatively, the first portion 1a may be overmolded onto the second portion 1b, for example according to a two-step process, for example after the molding of the second portion 1b.

The second portion 1b may have the through-hole 7. The second portion 1b may for example have a shape chosen among one of the following: a cuboid, a rectangular prim, a parallelepiped. However, the second portion 1b may have any other shape. In the embodiment shown in FIGS. 1 to 6c, the second portion 1b has a parallelepiped shaped.

FIG. 1 shows the compressible part 2 extending along an axis X of the through-hole 7.

In the embodiment presented in FIG. 1, the entirety of the compressible part 2 extends in the through-hole 7. In other words, the dimension of the compressible part 2 according to an axis X of the through hole 7 is lesser than the dimension of the through-hole 7 along the same axis X.

However, it is also possible that only part of the compressible part 2 extends in the through-hole 7.

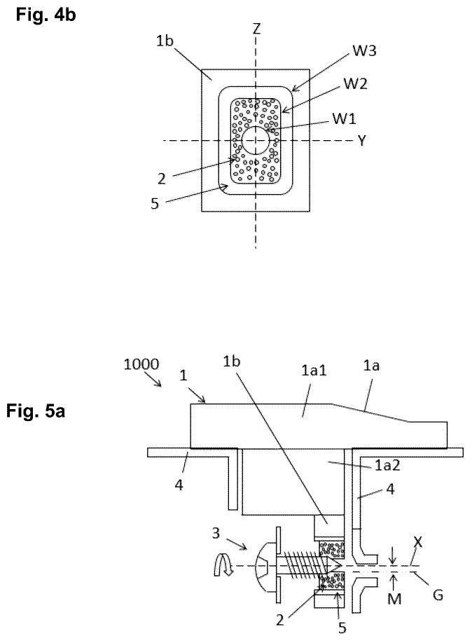

As can be seen in the sectional view according to section AA in FIG. 4b, the compressible part 2 may extend radially with respect to said axis X, towards the handle part 1, for example towards the second portion 1b.

The compressible part 2 may be configured to receive a screwing assembly 3. In other words, at least part of the screwing assembly 3 can be pressed into the compressible part 2 so as to penetrate and pass through the compressible part 2. By screwing assembly, it is for example meant an assembly comprising a screw, otherwise called screwing mechanism.

By the screwing assembly 3 can be pressed into the compressible part 2 so as to penetrate and pass through the compressible part 2, it is for example meant that the screwing assembly 3 can break through the compressible part 2 if the compressible part 2 does not have a hole in it.

Alternatively, the compressible part 2 may have a hole 6 adapted to receive at least part of the screwing assembly 3 so as to allow to assemble together the handle part 1 and a door panel 4. The hole may have a circular shape 6 and/or may have a diameter comprised between M1 and M10, preferably M5.

The hole 6 facilitates the insertion of the screwing assembly 3 into the compressible part 2.

In the example presented in FIG. 4b, the compressible part 2 extends radially from a first inner wall W1 between the hole 6 and the compressible part 2 towards a second inner wall W2 between the compressible part 2 and the metal part 5. The metal part 5 extends between the second inner wall W2 and a third inner wall W3 between the metal part 5 and the second portion 1b.

The compressible part 2 may comprise an elastomer, in particular foam or rubber. Elastomers are generally very durable and resistant to wear and tear. For example, the compressible part 2 may comprise an elastomer, for example TPE, TPV, EPDM.

The compressible part 2 may be configured to deform when in contact with the screwing assembly 3. In particular, the compressible part 2 may be configured to deform in at least one of the following directions, for example in any of the following directions: a direction orthogonal to an axis X of the through-hole 7 and a direction along an axis X of the through-hole 7. Alternatively, the compressible part 2 may deform in only one of these directions.

For example, while the compressible part 2 compresses in the direction along an axis X of the through-hole 7, compression of the compressible part 2 in the direction orthogonal to an axis X of the through-hole 7 may be restricted or prevented by the screwing assembly 3, and hence the screwing assembly 3 may exert a force on the compressible part 2 in the direction orthogonal to the axis X of the through-hole 7.

The compressible part 2 may deform and/or compress while keeping a constant volume.

When in a rest state, in other words, when the compressible part 2 is not in contact with the screwing assembly 3 and no other part is pressing on it, the compressible part 2 has an elongated ring shape, for example a cylindrical shape or an elliptical shape such as the one shown in FIG. 4b.

When in contact with at least part of the screwing assembly 3, that is when part of the screwing assembly 3 is pressing against the compressible part 2, the shape of the compressible part 2 may change and the compressible part 2 may deform and exert an elastic force on the part of the screwing assembly 3 that is inserted in the compressible part 2. The screwing assembly 3 is inserted at least partially in the compressible part 2. For example, the screwing assembly 3 is screwed at least partially in the compressible part 2.

Alternatively or in addition, when in contact with at least part of the screwing assembly 3, the compressible part 2 may permanently deform.

This allows to adjust the insertion path of the screwing assembly 3 into the compressible part 2 and therefore mitigate any misalignment between the handle and the door panel 4.

The metal part 5 is presented in FIGS. 1 to 6. The metal part 5 may also have an elongated ring shape, for example for example a cylindrical shape or an elliptical shape and it may comprise a metal chosen from the list comprising the following metals: steel, aluminum. The metal part 5 may be made of one of the metals chosen from the list comprising the following metals: steel, aluminum, brass.

The metal part 5 may be subject to a compression due to the insertion of the screwing assembly 3. The compression may depend on the screwing torque and on the metric of the screw. The compression may have a value of several kiloNewton, for instance 4000 Newton.

An elongated ring-shaped metal part has a good weight distribution, which means that it is less likely to cause vibration or noise. It is also easy to manufacture.

Advantageously, the metal part 5 can withstand high loads and forces without failing and does not deform easily under load.

The metal part 5 may have an elongated ring shape, for example an elliptical shape, for example such as the one presented in FIG. 4b, such that a dimension of the metal part 5 according to axis Z is larger than a dimension of the metal part according to axis Y.

The compressible part 2 and the through-hole 7 may have an elongated shape, for example an elongated shape corresponding to the metal part, for example the same elongated shape as the metal part 5 as can be seen in FIG. 4b.

Advantageously, this elongated shape increases the contact area with the screwing assembly 3 and provides better centering of said screwing assembly 3.

The metal part 5 that is extending at least partially around the compressible part 2 is the same metal part 5 that is extending at least partially between the handle part 1 and the compressible part 2.

The metal part 5 and the compressible part 2 may be arranged such that the metal part 5 extends further than the compressible part 2 along an axis X of the through-hole 7 as can be seen in FIG. 1 for instance.

This allows the compressible part 2 to deform along the same axis X upon reception of the screwing assembly 3.

The handle part 1 and the metal part 5 are fixedly connected so that no movement occurs between them. The metal part 5 may be inserted forcefully in the handle part 1 or overmolded in the handle part 1 or inserted using hot insertion in the handle part 1.

The compressible part 2 is fixedly connected to the metal part 5 so that the compressible part 2 is unable to slide along the central axis X with respect to the metal part 5.

As can be seen in FIG. 1, the compressible part 2 may extend only partially over the metal part. In other words, the compressible part may be of lesser length than the metal part 5.

The dimension of the metal part 5 along axis X may be equal or greater than the dimension of the second portion 1b along axis X, and the dimension of compressible part 2 along axis X may be less than or equal to the dimension of the metal part 5 along axis X. These dimensions guarantee metal to metal contact.

The second portion 1b may extend equally from both sides of the through-hole 7 with respect to axis Z and with respect to axis Y as can be seen in FIG. 4b.

Advantageously, the described structure of the door handle 10 is adapted to receive at least part of the screwing assembly 3 in order to be easily and conveniently assembled with the door panel 4 during the manufacturing process.

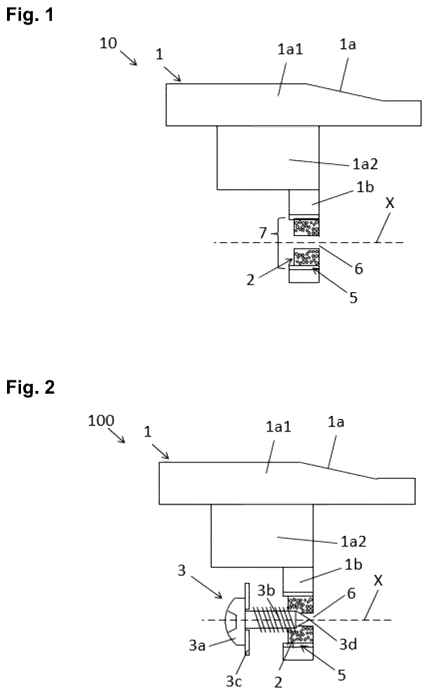

The invention further relates to a subassembly 100 of a door handle 10 and a screwing assembly 3. The subassembly is presented in FIG. 2.

The subassembly comprises the door handle 10 and the screwing assembly 3.

The screwing assembly 3 may comprise a screw configured to be inserted at least partially in the compressible part 2.

As can be seen in FIG. 2, the screw has a head 3a and a shaft 3b connected to the head 3a.

The shaft 3b may be threaded. A threaded shaft provides a more secure and reliable means of connecting together then door handle 10 and the screwing assembly 3.

If the shaft 3b is threaded and the compressible part 2 has a hole 6, then the hole 6 may be threaded as well. Otherwise, the hole 6 may be a non-threaded hole.

The shaft may have a tip 3d and the tip 3d may be a sharp one.

By a sharp tip, it is meant that the distal end of the shaft 3b with respect to the head 3a is sharper than the proximal end of the shaft 3b with respect to the head 3a, and that it is configured to pierce the compressible part 2.

The tip 3d may be a conical shaped tip.

The screwing assembly 3 may be inserted at least partially in the compressible part 2 as presented in FIG. 2. In other words, only part of the shaft 3b may be inserted in the compressible part 2 as presented in FIG. 2.

The screwing assembly 3 may also comprise a washer 3c configured to be positioned on the screw between a head 3a of the screw and around a shaft 3b of the screw as can be seen in FIG. 2.

The washer 3c helps in distributing the load or force applied by the screw on the second portion 1b so as to prevent the screw from damaging the handle part 1.

The washer 3c may be ring-shaped and may comprise steel or aluminum.

The washer 3c may be made of or comprise a metal, such as stainless steel for example.

The subassembly 100 may be assembled by inserting the screwing assembly 3, partially or entirely, in the compressible part 2. For example, FIG. 2 shows the screwing part 3 inserted partially in the compressible part 2, meaning that only part of the shaft 3b is inserted inside the compressible part 2, whereas FIG. 4a and FIG. 4b show the screwing assembly 3 entirely inserted in the compressible part 2, meaning that the screw is tightened until the washer is in contact with the metal part 5 and the shaft 3b passes through the compressible part 2.

Alternatively, if the screwing assembly does not have a washer 3c, the screw is tightened until the head of the screw 3a is in contact with the metal part 5 and the shaft 3b passes through the compressible part 2.

Whether partially or entirely inserted in the compressible part 2, the screwing assembly 3 may be subject to an elastic force exerted by the compressible part 2 on the part of the screwing assembly 3 that is inserted in the compressible part 2.

In order to exert this elastic force, the compressible part 2 deforms at least partially elastically and changes its shape so as to adjust the insertion path of the shaft 3b inside the compressible part 2.

The insertion path of the shaft 3b is the trajectory that the shaft 3b takes as it is driven into the compressible part towards the door panel 4.

The invention further relates to an assembly 1000 of the subassembly 100 and the door panel 4. The door panel 4 may be a motor vehicle door panel, more specifically a car door panel.

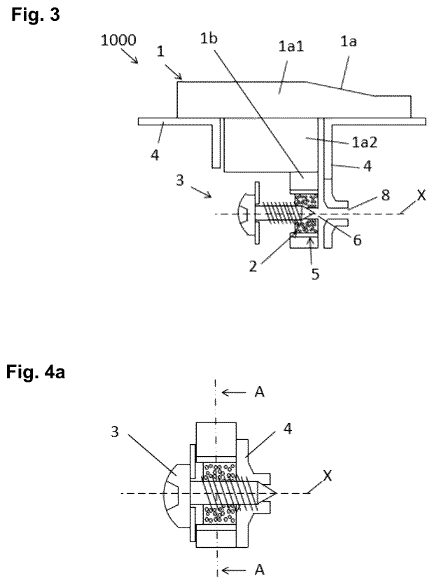

The assembly 1000, presented in FIG. 3, comprises the subassembly 100 and the door panel 4.

The door panel 4 has an aperture 8 adapted to receive at least part of the screwing assembly 3, so as to assemble together the subassembly 100 and the door panel 4.

As can be seen in FIG. 3, the door panel 4 may comprise two distinct parts that are separated by a space between them. This space is intended to receive the handle part 1, more specifically it is intended to receive the second part 1a2 of the first portion 1a and the entire second portion 1b.

FIG. 4a shows the screwing assembly 3 fully tightened and the handle part 10 assembled together with the door panel 4. In this case, the washer 3c is in direct contact with the metal part 5. This prevents the screw from sinking into the metal part 5 and damaging it and prevents the screwing assembly 3 from loosening.

Alternatively or in addition to a use of the washer 3c, the screwing assembly 3 may comprise a pan head screw or a screw with a high head diameter compared to the screw threading diameter.

The assembly 1000 allows mitigating any misalignment between the aperture 8 and the screwing assembly 3 that is due to manufacturing component tolerances.

The misalignment may include a tilt of the screwing assembly 3 with respect to the insertion path of the shaft 3b.

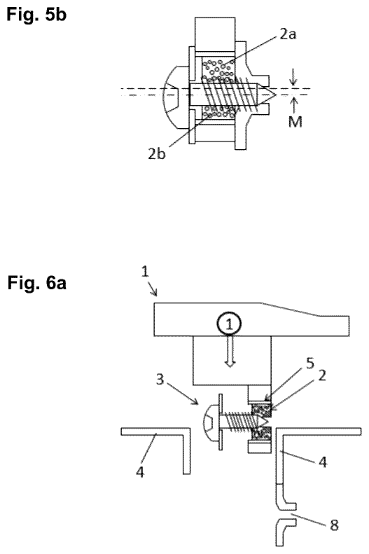

FIG. 5a first shows an example where the screwing assembly 3 is only partially inserted in the compressible part 2 and where misalignment M occurs between the subassembly 100 and the aperture 8. In other words, axis X that passes through the through-hole 7, in the center of the through-hole 7, and an axis G that passes through the aperture 8, in the center of aperture 8, do not coincide. In other words, there is an offset in a direction orthogonal to an axis of the through-hole 7 between axis X and axis G.

In this case, the compressible part 2 deforms on contact with the shaft 3b when the shaft 3b is guided by aperture 8 to adjust the trajectory of the screwing assembly 3 as it is tightened to assemble together the handle part 1 and the door panel 4. In other terms, the screwing assembly 3 causes the compressible part to compress in order to correct the misalignment M and to allow to assemble together the handle part 1 and the door panel 4.

FIG. 5b also shows the assembly 1000 when the screw has been fully tightened and the washer 3c is in contact with the metal part 5.

It can be seen, according to the cross-sectional view of FIG. 5b, that the lower part 2b of the compressible part 2 has a width less than the upper part 2a. This is due to the fact that the lower part 2b is being compressed by the shaft 3b so that the misalignment M is reduced so that the shaft 3b is able to pass, at least partially, through both the compressible part 2 and the aperture 8 in order to assemble together the handle part 1 and the door panel 4.

The invention further relates to a method for assembling the door panel 4 and the subassembly 100 or a method to obtain the assembly 1000.

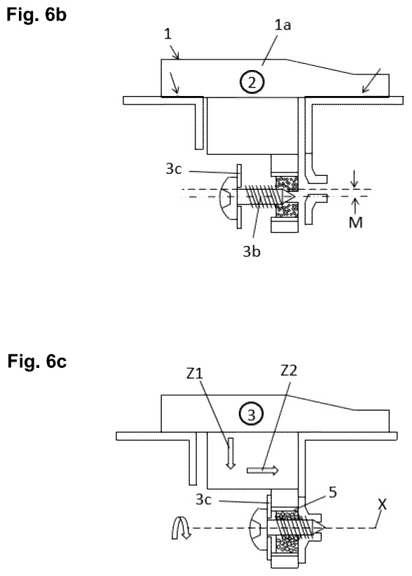

Steps of the method are presented in FIG. 6a, 6b, 6c.

The method first comprises a step of providing the subassembly 100 as presented in FIG. 6a. The subassembly is provided with the screwing assembly 3 inserted partially in the compressible part 2 so that the subassembly 100 is able to slide in the space between the two distinct parts of the door panel 4 as can be seen in FIG. 6b.

The subassembly is pushed towards the door panel 4 so that the first portion 1a is in contact with the door panel 4. In other words, the first portion 1a rests on the two distinct parts of the door panel 4 as shown in FIG. 6b.

Then the method comprises a step of positioning the subassembly 100 so as to have the compressible part 2 facing the aperture 8 of the door panel 4.

In this step, the second portion 1b is entirely inside the space between the two distinct parts of the door panel 4, and the compressible part 2 is positioned so as to face the aperture 8 of the door panel 4. In other words, the compressible part 2 is positioned so that the shaft 3b is able to, at least partially; pass through both the compressible part 2 and the aperture 8. Because of components manufacturing tolerances, the misalignment M can occur in this step.

The method further comprises a step of tightening the screwing assembly 3 until at least part of the screwing assembly 3 is in contact with the metal part 5, and until at least part of the screwing assembly 3 passes through both the compressible part 2 and the aperture 8 as can be seen in FIG. 6c. In other words, the screw is tightened, possibly with a screw driver, until the shaft 3b passes through both the compressible part 2 and the aperture 8 and the washer 3c (or the head of the screw 3a if no washer is present) is in contact with the metal part 5.

The tightening of the screw results in the door handle 10 being pushed both in a first direction Z1 orthogonal to an axis X of the through-hole 7 towards the inner side of the door panel 4, and in a second direction Z2 towards the part of the door handle 4 that has the aperture 8.

The inner side of the door panel 4 is the side of the door panel 4 that faces the inside of the car, the side that is not visible from the outside of the vehicle.

When the screwing assembly 3 is in contact with the compressible part 2, the compressible part 2 deforms and is able to change its shape in order to adjust the insertion path of the shaft 3b in the compressible part 2. This helps in reducing any misalignment that might occur between the screwing assembly 3 and the aperture 8. In other words, the compressible part 2 may exert an elastic force on the screwing assembly 3 so as to secure the subassembly 100 and the door panel 4 together.

Advantageously, the method uses a single screwing operation so it is simple and convenient during a vehicle manufacturing.

Although the invention has been described in relation to particular embodiments, it is clear that it is by no means limited thereto and that it includes all the technical equivalents of the means described, as well as combinations thereof, if these fall within the scope of the invention.

Unless otherwise expressly indicated herein, all numerical values indicating mechanical/thermal properties, compositional percentages, dimensions and/or tolerances, or other characteristics are to be understood as modified by the word “about” or “approximately” in describing the scope of the present disclosure. This modification is desired for various reasons including industrial practice, material, manufacturing, and assembly tolerances, and testing capability.

As used herein, the phrase at least one of A, B, and C should be construed to mean a logical (A OR B OR C), using a non-exclusive logical OR, and should not be construed to mean “at least one of A, at least one of B, and at least one of C.”

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. A door handle intended to be mounted on a door of a motor vehicle, comprising:
a handle part;
a compressible part adapted to receive at least part of a screwing assembly so as to allow to assemble together the handle part and a door panel; and
a metal part extending at least partially around the compressible part and at least partially between the handle part and the compressible part.

2. The door handle according to claim 1, wherein the compressible part has a hole adapted to receive at least part of the screwing assembly so as to allow to assemble together the handle part and a door panel.

3. The door handle according to claim 1, wherein the handle part has a through-hole, and the compressible part extends along an axis (X) of the through-hole, at least partially in the through-hole, and the compressible part extends, for example radially, from said axis (X) towards the handle part.

4. The door handle according to claim 1, wherein the compressible part is configured to deform when in contact with the screwing assembly.

5. The door handle according to claim 3, wherein the compressible part is configured to deform in at least one of the following directions: a direction orthogonal to an axis (X) of the through-hole and a direction along an axis (X) of the through-hole.

6. The door handle according to claim 3, wherein the metal part and the compressible part are arranged such that the metal part extends further than the compressible part along an axis (X) of the through-hole, for example so as to allow the compressible part to deform along the same axis (X) upon reception of the screwing assembly.

7. The door handle according to claim 1, wherein the compressible part and the metal part are ring-shaped.

8. The door handle according to claim 3, wherein the handle part comprises a first portion configured to rest on a door panel, for example on an outer side of a door panel, and a second portion having the through-hole and extending from the first portion, for example in a direction orthogonal to an axis (X) of the through-hole.

9. The door handle according to claim 1, wherein the compressible part comprises an elastomer, in particular foam or rubber.

10. The door handle according to claim 1, wherein the metal part comprises a metal chosen from a group consisting of steel, aluminum, and brass.

11. A subassembly, comprising:
the door handle according to claim 1; and
a screwing assembly comprising a screw configured to be inserted at least partially in the compressible part of the door handle.

12. The subassembly according to claim 11, wherein the screwing assembly is inserted at least partially in the compressible part.

13. The subassembly according to claim 11, wherein the screw has a sharp tip.

14. The subassembly according to claim 11, wherein the screwing assembly comprises a washer configured to be positioned on the screw between a head of the screw and around a shaft of the screw.

15. An assembly comprising:
the subassembly according to claim 11; and
a door panel having an aperture adapted to receive at least part of the screwing assembly, so as to assemble together the subassembly and the door panel.

16. A method for assembling a door panel and the subassembly according to claim 11, the method comprising:
providing the subassembly;
positioning the subassembly so as to have the compressible part facing an aperture of the door panel; and
tightening the screwing assembly until:
at least part of the screwing assembly is in contact with the metal part, and until
at least part of the screwing assembly passes through both the compressible part and the aperture, and
when the screwing assembly is in contact with the compressible part, the compressible part deforms and exerts an elastic force on the screwing assembly so as to secure the subassembly and the door panel together.
